(19) United States
(12) Patent Application Publication
(10) Pub. No.: US 2026/0213463 A1
(43) Pub. Date: Jul. 23, 2026

(54) PLUG CONNECTOR INSERT FOR AN ELECTRICAL PLUG CONNECTOR

(71) Applicant: HARTING Electric Stiftung & Co. KG, Espelkamp (DE)

(72) Inventors: Dieter RIEPE, Luebbecke (DE); Svea MEIER, Espelkamp (DE)

(73) Assignee: HARTING Electric Stiftung & Co. KG, Espelkamp (DE)

(21) Appl. No.: 19/132,835

(22) PCT Filed: Nov. 20, 2023
(86) PCT No.: PCT/DE2023/100896

§ 371 Date: May 26, 2025

(30) Foreign Application Priority Data
Dec. 13, 2022 (DE) 10 2022 133 138.5

(51) Int. Cl. H01R 13/652; H01R 43/20

(52) U.S. Cl. CPC H01R 13/652; H01R 43/20

(57) ABSTRACT

In order to reduce the effort required for assembling a plug connector insert for crimp contacts (2), its PE (Protective Earth) connecting element (1) is inserted into an insulating body (3) on the cable connection side and is then permanently fixed in place in the contact carrier by means of a retaining plate (4) which is snapped onto the insulating body (3) on the cable connection side.

### CROSS-REFERENCE TO RELATED APPLICATIONS

This application is a national stage application, filed under 35 U.S.C. § 371, of International Patent Application PCT/DE 2023/100896, filed on Nov. 20, 2023, which claims the benefit of German Patent Application DE 10 2022 133 138.5, filed on Dec. 13, 2022.

### TECHNICAL FIELD

The disclosure relates to a plug connector insert for an electrical plug connector, to an electrical plug connector having the plug connector insert and a plug connector housing, to a method for assembling a plug connector insert, and toa method for assembling an electrical plug connector.

### BACKGROUND

Plug connector inserts of this type are used for insertion into a metal plug connector housing and earthing the latter electrically, in order thus to produce a plug connector which serves for electrical plugged connection to a mating plug connector. Such a plug insert has a contact carrier which has a two-part design, for construction-related, in particular injection-molding reasons, and can be formed, for example, from an insulating body and a retaining plate. Plug contacts of the plug connector are electrically conductively connected to mating plug contacts of the mating plug connector by reversibly plug-connecting the plug connector to a mating plug connector such that in each case one plug contact pair, consisting of a plug contact and a mating plug contact plugged to it, is formed. In each case one electrical cable with a plurality of electrical lines can be firmly connected to the plug connector and the mating plug connector on the cable connection side. By plugging the plug connector to the mating plug connector, the electrical lines which are connected to a cable connection region of the respective plug contact and the respective mating plug contact are thus also connected to each other electrically conductively in pairs in order to transmit electrical signals and/or energy between the two cables. The proper protective earthing of the metal plug connector housing can additionally serve to electrically and/or magnetically shield the electrical signals inside the plug connector.

The document DE 10 2010 022 690 B4 discloses an electrical plug connector having a plug connector housing and an insulating body. At least one contact element as well as an earth connection contact element can be inserted into the insulating body and can be latched therein. It is furthermore disclosed to configure the earth connection contact element as a crimped contact. For the earthing connection of the earth connection contact element to the plug connector housing, a contact plate which can be attached to the side is provided which can be inserted inside a recess of the insulating body via lateral slots and can be latched therein, and is in electrically conductive contact with the earth connection contact element in the inserted state. The contact plate has a threaded bore in its base and can thus be connected electrically conductively to the plug connector housing via a screw connection. The contact plate is designed as a U-shaped component such that the lateral flanks of the contact plate have guide arms and latching arms, wherein the guide arms latch onto an undercut of the insulating body, and wherein the latching arms engage in notches of the insulating body.

A disadvantage of this prior art is the large amount of effort required to produce and assemble the plug connector because the assembly of the contact plate requires a separate assembly step from a separate assembly direction, and its insertion from the side by means of the guide and latching arms which latch onto undercuts and notches requires a certain degree of skill. Such assembly therefore has to be performed manually and cannot be automated, or at least not with a reasonable amount of effort.

The German Patent and Trademark Office has conducted a search and found the following prior art in the priority application to the present application: DE 100 09 750 A1, DE 20 2006 003 204 U1, WO 2022/171241 A1, and WO 2022/171242 A1.

### SUMMARY

An object of the disclosure consists in specifying a structure and an assembly method for a plug connector insert by means of which the plug connector insert can be produced with as little assembly effort as possible. It is in particular intended that the plug insert, and preferably also the whole plug connector, can be produced in an automated manner.

The object is achieved by the respective subject-matter of the independent claims.

Advantageous embodiments of the invention are specified in the dependent claims and the following description.

A plug connector insert serves as a constituent part of an electrical plug connector and is configured for insertion into a metal plug connector housing and for protective earthing thereof.

The plug connector insert has a plurality of in each case one-part plug contacts. The plug contacts in each case have a plug-in region, a retaining collar, and a cable connection region separated from the plug-in region by the retaining collar. The cable connection region of the plug contacts is designed as a crimped connection such that the plug contacts are crimped contacts.

One of these plug contacts serves at the cable connection side for connection to a PE (“protective earth”) line and serves at the plugging side for PE transmission to a mating plug connector such that this plug contact is a PE contact.

The plug connector insert furthermore has an electrically conductive separate PE connecting element. This PE connecting element serves, on one side, for the mechanical and electrically conductive contacting of the PE contact and, on the other side, for the electrical and mechanical contacting of the metal plug connector housing and for fastening the plug connector insert in the metal plug connector housing. To do this, the PE connecting element has a cylindrical screw opening. This screw opening has an internal thread for screwing it onto the plug connector housing.

The plug connector insert furthermore has a contact carrier. The contact carrier has an insulating body with a plugging side and a cable connection side situated opposite the plugging side. The plug connector insert furthermore has a retaining plate which can be latched to the insulating body at the cable connection side.

The retaining plate has, for each contact chamber, an insertion opening for insertion of the plug contact into the respective contact chamber.

The cable connection side and the plugging side are connected to each other via four outer faces, arranged at right angles to one another, of the substantially cuboid insulating body. One of these outer faces is a PE outer face.

The insulating body has a plurality of contact chambers, configured as through openings, for receiving in each case one plug contact. The contact chambers are oriented in a plugging direction running parallel to the outer faces and thus connect the cable connection side and the plugging side of the insulating body to each other.

One of the contact chambers is arranged on the PE outer face and serves to receive the PE contact. This contact chamber is thus a PE contact chamber.

The PE contact chamber is open in the direction of the PE outer face. As a result, a PE opening is formed in the PE outer face. This PE opening enables electrical and mechanical contacting of the PE connecting element to the plug connector housing.

The insulating body and the retaining plate are configured to retain the plug contacts to be inserted and/or which have already been inserted in the contact carrier in the latched-together state. This can be effected by latching arms which are integrally formed on the retaining plate and project into the contact chambers.

When the plug connector insert is assembled, the PE connecting element can initially be pushed into the PE contact chamber of the insulating body at the cable connection side, can be retained in form-fitting fashion therein and initially movably in the plugging direction, and can be definitively fixed in the contact carrier by subsequent latching of the retaining plate to the insulating body.

The plug connector insert can be assembled according to a method with the following steps:
A. inserting the PE connecting element into the PE contact chamber at the cable connection side;
B. fixing the PE connecting element in the PE contact chamber by latching the retaining plate to the insulating body at the cable connection side;
C. inserting the plug contacts, including the PE contact, in a direction from the cable connection side, through in each case one of the insertion openings of the retaining plate, into the respective contact chambers, wherein the PE contact is inserted into the PE contact chamber;
D. latching the plug contacts in their respective contact chambers, wherein the PE contact is latched in the PE contact chamber and additionally contacts the PE connecting element electrically and mechanically.

The method steps are here largely performed in the predetermined sequence A; B; C, and D, wherein the order of the method steps C and D relative to each other is not fixed precisely because a plurality of plug contacts are ultimately inserted into their respective contact chambers and the specified sequence can be fixed meaningfully only for each individual plug contact.

An electrical plug connector has a metal plug connector housing and plug connector insert of the abovementioned type inserted therein, wherein the plug connector insert is screwed with its PE connecting element to the plug connector housing by means of a screw.

The plug connector can be implemented according to the abovementioned method with the said method steps A, B, C, and D as well as the following subsequent steps:
E. inserting the plug insert into the plug connector housing;
F. fixedly screwing the plug connector insert by means of its cylindrical screw opening and the said screw onto the plug connector housing and consequently electrically conductively connecting the PE connecting element to the plug connector housing.

In particular, the method step F is here particularly advantageous because the PE connecting element can be drawn, in particular with its base, by being screwed in, so that it lies flat and with a high contact force inside, against the plug connector housing and this ensures a particularly high-quality electrically conductive connection.

In a preferred embodiment, the electrically conductive connecting of the PE connecting element to the plug connector housing in method step F can take place by the base of the PE connecting element being drawn from inside against the plug connector housing by, as mentioned above, being screwed on so as to fix it, whilst the PE connecting element electrically contacts the PE contact on both sides simultaneously with its contact tabs. A particularly reliable and particularly effective electrically conductive connection between the PE contact and the plug connector housing is produced as a result.

The fact that the plug contacts are crimped contacts is, in addition to the usually high stability and the excellent electrical conductivity that the crimped connections generally have, also therefore particularly advantageous because in this way the plug contacts can be inserted into the contact carrier of the plug connector insert in the so-called pre-assembled state, i.e. in a state in which they are already connected to their respective electrical line. The crimping thus takes place already before the abovedescribed assembly of the plug connector insert begins. It is particularly advantageous here that pre-assembled contacts can be used, i.e. that, for example, a cable with a plurality of electrical lines and plug contacts which are already crimped thereto with a guaranteed high and consistent quality can be bought prior to assembly and be used during assembly. It is particularly advantageous here that the PE contact is a crimped contact. This also facilitates the quality assurance and assembly because only plug contacts of one connection type have to be used in the same way, i.e. crimped contacts by crimping.

It is furthermore particularly advantageous that both the PE connecting element and the plug contacts are inserted into the insulating body/contact carrier exclusively in a direction from the cable connection side. In addition, the retaining plate is also latched to the insulating body in a direction from the cable connection side such that overall only one assembly direction exists for the assembly of the plug connector insert. This significantly facilitates the assembly of the plug connector insert and additionally improves its automatability.

The plug connector insert has the advantage that it has a particularly compact structure, i.e. small geometrical dimensions compared with the cable cross sections used. This is made possible by the compactly designed PE connecting element and the one-part particularly compact crimped contacts. The air gaps and creepage distances are consequently small compared with the predetermined structural space such that relatively high electrical voltages can be applied at the plug contacts. This plug connector insert and the plug connector equipped therewith thus have both a particularly high current carrying capacity and a particularly high dielectric strength.

In a preferred embodiment, the retaining plate has a latching arm which projects into the respective contact chamber in order to latch each plug contact inserted into the contact carrier. As a result, a plug contact inserted at the cable connection side into the contact carrier through the respective insertion opening of the retaining plate can latch in the respective contact chamber onto the respective latching arm with its retaining collar.

In a preferred development of the invention, the PE connecting element has at least one plugging-side fixing lug for stabilizing engagement in a retaining pocket, arranged at a plugging-side end of the PE contact chamber, of the insulating body.

This is particularly advantageous for retaining the PE connecting element in the contact chamber in a particularly stable fashion, in particular also at a time when the retaining plate has not yet been latched to the insulating body.

In a preferred embodiment, in the unlatched state of the retaining plate, the PE connecting element is retained movably in the plugging direction in the PE contact chamber of the insulating body. As a result, the PE connecting element can advantageously be pushed into the contact carrier in a direction from the cable connection side, can be moved into its ultimate position, and finally can be definitively fixed by means of the retaining plate.

In a further advantageous embodiment, the PE connecting element can be formed cost-effectively and effortlessly as a stamped and bent part from a resilient sheet-metal part.

In a preferred embodiment, the PE connecting element can contact the PE contact electrically and mechanically on both sides. For this purpose, the PE connecting element can have two contact tabs, facing in the plugging direction and which are free-standing at their ends, of the PE contact.

In a further advantageous embodiment, the PE connecting element can have two side walls and one base as the contact surface. The said screw opening can then be arranged in the base. During screwing to the metal plug connector housing, the base of the PE connecting element can thus be drawn against the plug connector housing by the screwing-on force and consequently electrically contact the plug connector housing over a wide surface, which ensures a particularly effective and secure electrical connection. The two side walls can be bent at right angles to the base of the PE element such that the PE connecting element has a substantially U-shaped cross section. Each of the two contact tabs can be stamped from in each case one of these side walls and bent inward in order to contact the said plug contact, inserted along these contact tabs at the cable connection side, mechanically and electrically conductively on both sides.

In a preferred embodiment, the PE connecting element can have at each of its two side walls in each case at least one outwardly directed skid for engaging behind in each case one sliding edge of the insulating body. This serves to facilitate the insertion of the PE connecting element into the insulating body and to retain the PE connecting element in the insulating body movably in the plugging direction until it latches onto the retaining plate. At the same time, these features can advantageously be implemented with only a very small amount of manufacturing effort.

Each of these two sliding edges of the insulating body can be a constituent part of in each case one of two guide slots of the insulating body which are oriented parallel to the PE outer face. These two guide slots can be arranged at two opposing sides of the PE contact chamber. The two guide slots can begin at the cable connection side and extend from there in the plugging direction. Each of the skids of the PE connecting element inserted into the insulating body can thus engage in in each case one of the guide slots in order to retain the PE connecting element in the insulating body so that it can be displaced initially in the plugging direction.

In a preferred development, the retaining plate has latching means for latching to mating latching means of the insulating body. For example, the retaining plate can have latching tabs with latching windows as latching means which can latch onto mating latching means, designed as latching moldings, of the insulating body which are designed, for example, as ramp-like latching hooks with in each case one slide-up slope and in each case one retaining surface. The mating latching means can be arranged on two opposing outer sides of the insulating body. Preferably neither of the two opposing outer faces are the PE outer face. This is particularly advantageous because otherwise the PE recess would make it difficult for the mating latching means to be present or prevent their presence.

Alternatively or additionally, grooved pins which are known very well to a person skilled in the art can also be used to fasten the retaining plate on the contact carrier.

In a further preferred embodiment, the metal plug connector housing has a contact rib on the inside. In the contact rib, the plug connector housing can have a cylindrical through opening for the passage of the screw to be screwed into the screw opening of the PE connecting element. The contact rib on the inside of the plug connector housing can thus partially engage in the PE opening of the contact carrier in order to be pressed against the contact surface of the PE connecting element by means of the abovementioned screwing and thus connect the plug connector housing mechanically and electrically conductively to the PE connecting element. In addition, the contact rib can be used for polarization protection to ensure the correct orientation of the plug connector insert relative to the plug connector housing.

In a preferred embodiment, the retaining plate can have at least one retaining rib which, in the latched-together state of the retaining plate, abuts at the cable connection side the PE connecting element inserted into the PE contact chamber in order to definitively fix the PE connecting element in the contact carrier. In particular, the retaining plate can have two retaining ribs, in each case one of which abuts one of the two side walls of the PE connecting element in the latched-together state of the retaining plate. These two retaining ribs can be arranged on both sides of the latching arm which serves to fix the PE contact and is therefore referred to as a PE latching arm.

### BRIEF DESCRIPTION OF THE DRAWINGS

An exemplary embodiment of the invention is illustrated in the drawings and explained in detail below. In the drawings:

FIG. 1a, b show a PE connecting element in two different views;

FIG. 2a, b show the PE connecting element with a PE contact contacted therein on both sides in two different views;

FIG. 3 show a contact carrier, formed from an insulating body and a retaining plate which can be latched thereto;

FIG. 4a, b show the insulating body with the PE connecting element to be inserted into it in two different views;

FIG. 5 shows the plug connector insert, having the insulating body, the PE connecting element, the retaining plate, and the PE contact, in an exploded illustration;

FIG. 6 shows the plug connector housing with the plug connector insert, inserted and screwed therein, without the PE contact, in an illustration in section.

### DETAILED DESCRIPTION

The Figures contain partially simplified schematic illustrations. Identical reference signs are used in part for the same but possibly non-identical elements. Different views of the same elements could be at different scales. Specified directions such as, for example, “left”, “right”, “up”, and “down” are to be understood with reference to the respective Figure and can vary with respect to the object illustrated in the individual illustrations.

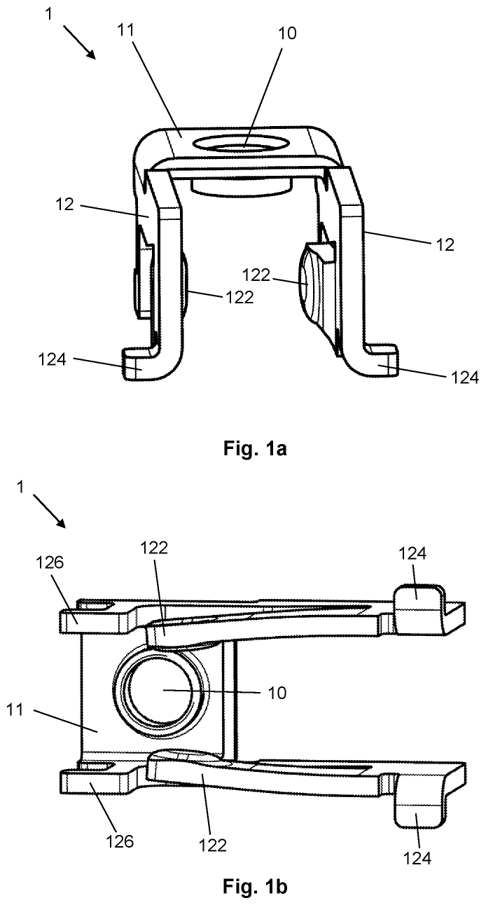

FIGS. 1a and 1b show a PE connecting element 1 of a plug connector insert in two different views.

The PE connecting element 1 is designed as a single part and can be produced cost-effectively and with minimal effort as a stamped and bent part from a resilient sheet-metal part.

The PE connecting element 1 has two side walls 12 and a base 11, connecting these two side walls 12, as a contact surface for electrically and mechanically contacting a metal plug connector housing 5 shown in FIG. 6. A screw opening 10 is arranged in the base 11. The screw opening 10 has an internal thread, not shown explicitly here, for screwing and fastening in the plug connector housing 5 by means of a screw 6 shown in FIG. 6.

The two side walls 12 of the PE connecting element 1 are bent at right angles to the base 11 such that the PE connecting element 1 has a substantially U-shaped cross section in the region of the base 11. In each case one contact tab 122 is stamped out from each of these side walls 12 and bent slightly inward.

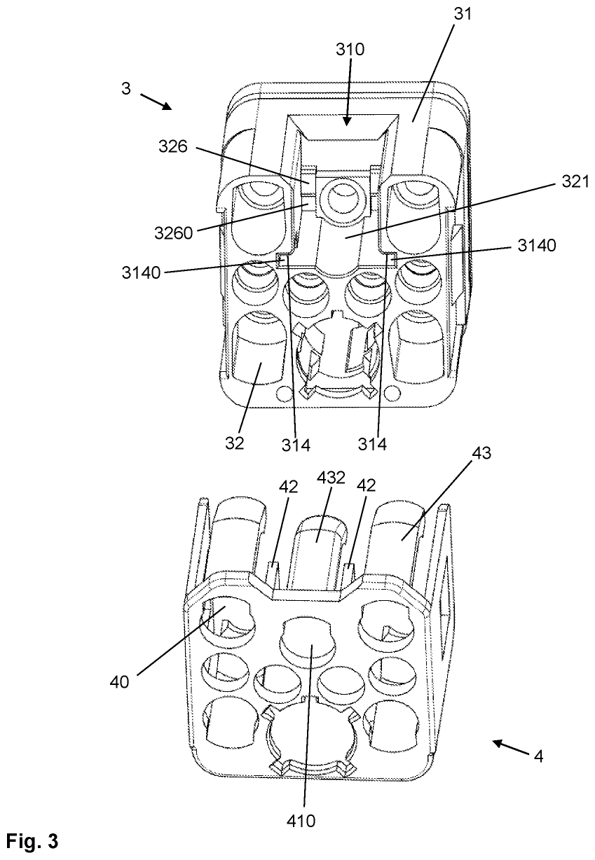

The PE connecting element 1 has, on each of its two side walls 12, an outwardly directed skid 124 for engaging behind in each case one sliding edge 314 of an insulating body 3 shown in FIG. 3.

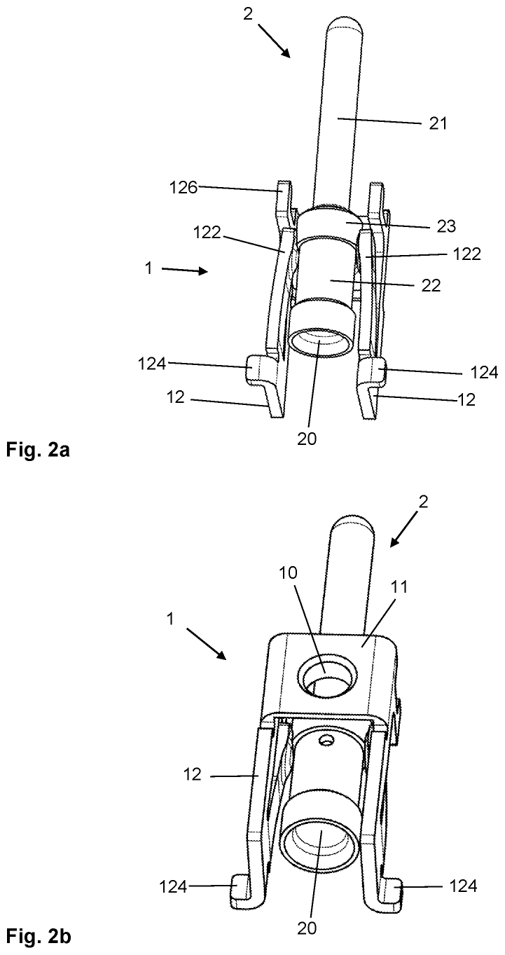

FIGS. 2a and 2b show the PE connecting element 1 with a PE contact 2 arranged therein. It is clear here that the two contact tabs 122 of the PE connecting element 1 contact the PE contact 2 on both sides mechanically, and thus also electrically.

The PE contact 2 has a plugging region 21, a retaining collar 23, and a cable connection region 22 separated from the plugging region 21 by the retaining collar 23. The cable connection region 22 of the PE contact 2 is designed as a crimped connection and thus has a crimped opening 20 for the insertion and crimping of an earth line (not shown) such that the PE contact 2 is a crimped contact.

The PE connecting element 1 is thus configured to connect the PE contact 2, and thus the said earth line connected to the PE contact 2 by crimping, electrically conductively to the plug connector housing 5.

The PE connecting element 1 furthermore has a plugging-side fixing lug 126 at each of its two side walls 12.

FIG. 3 shows an insulating body 3 with a view of its cable connection side and a retaining plate 4 which can be latched at the cable connection side to the insulating body 3. Opposite the cable connection side, the insulating body 3 has a plugging side which is concealed by the insulating body 3 itself and thus cannot be seen.

The cable connection side and the plugging side of the insulating body 3 are connected to each other via four outer faces 34, 31, arranged at right angles to one another, of the substantially cuboid insulating body 3, wherein one of these outer faces 34, 31 is a PE outer face 31.

The insulating body 3 has a plurality of contact chambers 32, designed as through openings, for receiving in each case one of the plug contacts. The contact chambers 32 and the further plug contacts (not shown here) can here be of different sizes. Apart from the in part different size, the further plug contacts are constructed in a substantially comparable fashion to the PE contact 2 shown above. The PE contact 2 is thus one of these plug contacts.

The contact chambers 32 are oriented in a plugging direction running parallel to the outer faces 31, 34 and thus connect the cable connection side and the plugging side of the insulating body 3 to each other.

One of the contact chambers 32 is arranged on the PE outer face 31 of the insulating body 3 and serves to receive the PE contact such that this contact chamber is a PE contact chamber 321.

The PE contact chamber 321 is open toward the PE outer face 31 and thus has a PE opening 310 arranged in the PE outer face 31. This PE opening 310 enables the electrical and mechanical contacting of the PE connecting element 1 to the plug connector housing 5.

The retaining plate 4 has latching means, explained in detail below, for latching to the insulating body 3. The retaining plate 4 can additionally have grooved pins. Furthermore, the retaining plate 4 has for each contact chamber 32 an insertion opening 40, 410 which is arranged at the respective contact chamber 32 for the insertion of the plug contact into the respective contact chamber 32, 321 in the latched-together state of the retaining plate 4. For the PE contact 2, the retaining plate has, for example, a PE insertion opening 410 which is arranged at the PE contact chamber 321.

The retaining plate 4 has a latching arm 43 for each plug contact in order to latch in place each plug contact inserted into the contact carrier, i.e. the PE contact too. When the retaining plate 4 is latched to the insulating body 3, the respective latching arm 43 projects into the respective contact chamber 32. As a result, a plug contact inserted at the cable connection side into the contact carrier through the respective insertion opening 40 of the retaining plate 4 can be latched in the respective contact chamber 32 to the respective latching arm 43 with its retaining collar 23. In particular, the PE contact 2 can be latched to its PE latching arm 432 of the retaining plate 4 in the PE contact chamber 321.

As a result, the contact carrier, consisting of the insulating body 3 and the retaining plate 4, is configured to retain in the contact carrier the plug contacts which are to be inserted and/or have already been inserted. In other words, the retaining plate 4 and the insulating body 3 are capable in the latched-together state of retaining the plug contacts which are to be inserted and/or have already been inserted, in particular the PE contact 2, in the insulating body 3.

Furthermore, two lateral guide slots 3140 at the upper end of which in each case a sliding edge 324 is situated can be seen in the lower region, in this illustration, of the PE contact chamber 321.

The skids 124 of the pushed-in PE connecting element 1 engage in these guide slots 3140 and, when the PE connecting element 1 slides more deeply into the contact chamber, slide along the sliding edge 314. It is thus prevented that the PE connecting element 1 can fall out of the insulating body 3 through the PE opening 310.

In addition, in each case one retaining pocket 3260, which is formed by a retaining molding 326 illustrated situated above it in the drawings, is arranged on both sides at the plugging-side end portion of the PE contact chamber 321. The fixing lugs 126 of the PE connecting element 1 which is pushed in until it abuts the plugging side engage in these retaining pockets 3260 in stabilizing fashion.

Two retaining ribs 42 pointing in the plugging direction are arranged on the retaining plate 4 on both sides of the PE latching arm 432. They serve to definitively fix the PE connecting element 1, which is pushed into the PE contact chamber 321 at the cable connection side, in the PE contact chamber 321 by the retaining ribs 42 abutting the side walls 12 of the PE connecting element 1 when the retaining plate 4 is latched to the insulating body 3.

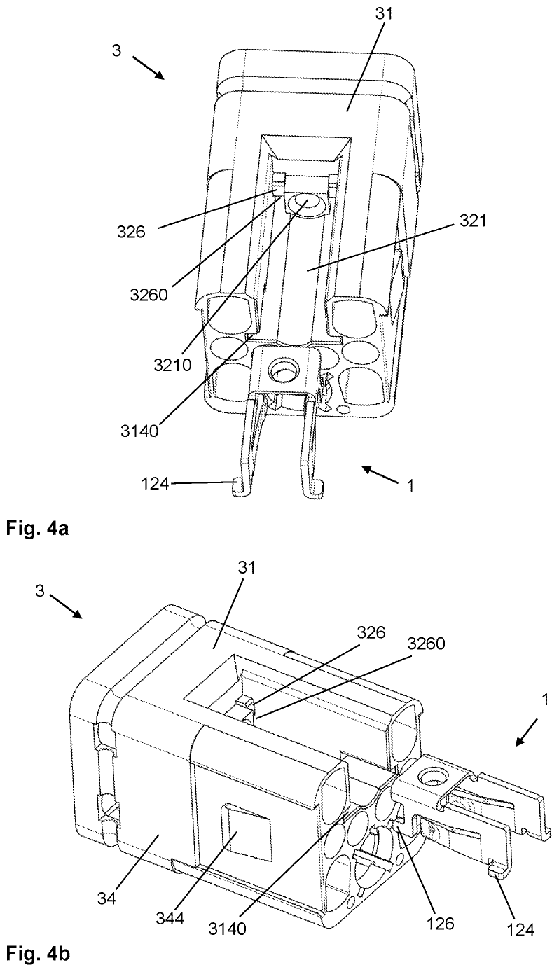

FIGS. 4a and 4b show the insulating body 3 with the PE connecting element 1 to be pushed in from two different perspectives. It can be seen particularly clearly here how the skids 124 engage in the guide slots 3140 and the fixing lugs 126 engage in the retaining pockets 3260 as soon as the PE connecting element 1 is pushed into the PE contact chamber 321. The skids 124 thus serve to facilitate the insertion of the PE connecting element 1 into the insulating body 3 and to retain the PE connecting element 1 movably in the plugging direction in the insulating body 3 until the retaining plate 4 latches on. At the same time, the skids 124 and the guide slots 3140 can be implemented with a very low degree of additional manufacturing effort.

The PE contact opening 321 furthermore has a contact pin opening 3210 for receiving the plug-in region 21 of the PE contact 2.

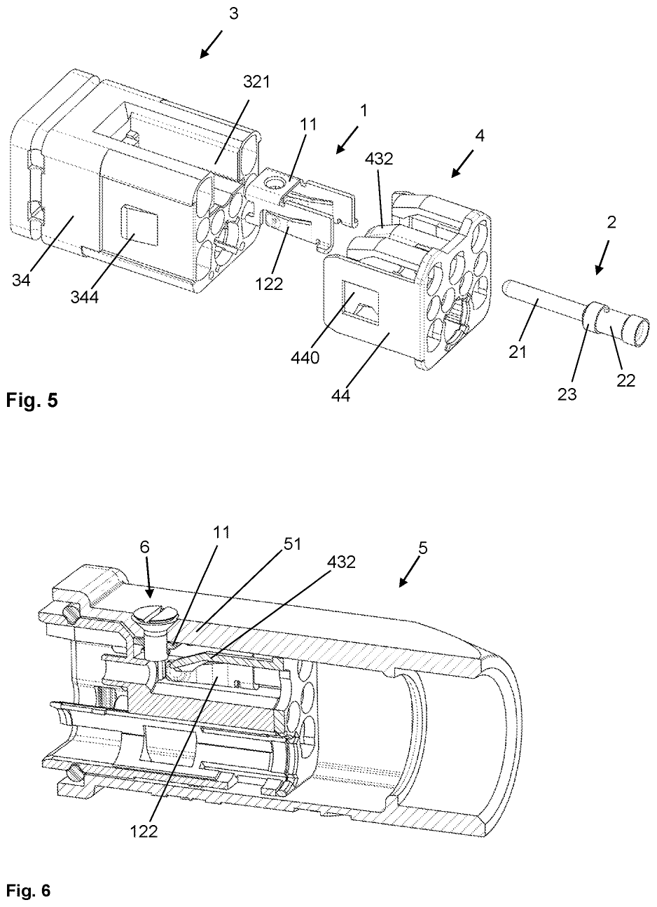

FIG. 5 shows again the abovementioned parts of the plug connector housing in an exploded illustration, namely the insulating body 3, the PE connecting element 1, the retaining plate 4, and the PE contact 2, wherein the PE contact 2 is representative of the other plug contacts of the plug connector insert too, which are not explicitly illustrated here for reasons of clarity.

From this perspective, the latching means of the retaining plate 4, namely the latching tabs 44 with their latching windows 440, can also be clearly seen. They serve to latch to the mating latching means, designed as latching moldings 344, of the insulating body 3. These mating latching means are designed as ramp-like latching hooks 344 with in each case one slide-on slope and in each case one retaining surface, and are arranged on two opposing outer faces 34, parallel to each other, of the insulating body 3 which are connected to each other via the PE outer face 31. However, only one of these outer faces 34 with the latching hooks 344 integrally formed thereon can be seen in the drawings because the other one is concealed by the insulating body 3.

In addition, also clear from this illustration is the assembly sequence in which first the PE connecting element 1 is pushed into the contact chamber 321 of the insulating body 3 and then the retaining plate 4 is latched onto the insulating body 3, as a result of which the PE connecting element 1 is definitively fixed in the PE contact chamber 321 of the insulating body 3, and finally the PE contact 2 and the further plug contacts (not illustrated) with electrical lines (likewise not illustrated) connected, namely crimped, thereto are inserted into the contact carrier through the insertion openings 40 of the retaining plate 4 and latch into their respective contact chambers 32.

Finally, FIG. 6 shows, as already indicated, a plug connector having a metal plug connector housing 5 with a housing wall 51 and the plug connector insert in a cross section through the PE connecting element 1. For reasons of clarity, the PE contact 2 is not shown here in order thus to offer a view of the other components.

Shown here for the first time is the screw 6 which is screwed into the screw opening 10 of the PE connecting element 1 from outside through the plug connector housing 5 through a threadless through opening of the housing wall 51 of the plug connector housing 5. As a result, the screw 6 draws the base 11 of the PE connecting element 1 with a corresponding screwing-on force from inside against the housing wall 51 of the plug connector housing 5 such that the PE connecting element 1 mechanically and electrically contacts the plug connector housing reliably and over a wide surface.

It is furthermore clear that when the PE contact 2 (not illustrated here), coming from the right in the drawing, is inserted into the PE contact chamber 321, it is latched with its retaining collar 23 on the PE latching arm 432 of the retaining plate 4 and in addition mechanically and electrically contacts the two contact tabs 122 of the PE connecting element 1 on both sides. The arrangement shown is thus capable, with only a small amount of effort required to assemble it, of reliably electrically connecting an earth line crimped to the PE contact 2 both to a mating plug connector for earthing transmission and to the metal plug connector housing 5.

### LIST OF REFERENCE SIGNS

1 PE connecting element
10 screw opening
11 base
12 side walls
122 contact tabs
124 skid
126 fixing lug
2 PE contact/plug contact/crimped contact
20 crimped opening
21 plugging region
22 cable connection region/crimped connection
23 retaining collar
3 insulating body
31 PE outer face
310 PE opening
314 sliding edge
3140 guide slot
32 contact chambers
321 PE contact chamber
3210 PE contact pin opening
326 retaining molding
3260 retaining pocket
34 outer face
344 latching molding/latching hook
4 retaining plate
40 insertion openings
410 PE insertion opening
42 retaining ribs
43 latching arms
432 PE latching arm
44 latching tab
440 latching window
5 plug connector housing
51 housing wall
6 screw

1.-16. (canceled)

17. A plug connector insert for an electrical plug connector, the plug connector insert being configured for insertion into a metal plug connector housing (5) and for protective earthing of the metal plug connector housing (5), the plug connector insert comprising:
a plurality of one-part plug contacts (2), each of the one-part plug contacts (2) having a plug-in region (21), a retaining collar (23), and a cable connection region (22) separated from the plug-in region (21) by the retaining collar (23), wherein the cable connection region (22) of the plug contacts (2) is designed as a crimped connection such that the plug contacts (2) are crimped contacts,
wherein one of the one-part plug contacts (2) serves at a cable connection side for connection to a PE line and serves at a plugging side for PE transmission to a mating plug connector such that this plug contact (2) is a PE (“protective earth”) contact;
an electrically conductive separate PE connecting element (1) for, on one side, a mechanical and electrically conductive contacting of the PE contact (2) and, on another side, for an electrical and mechanical contacting of the metal plug connector housing (5) by a cylindrical screw opening (10), belonging to the PE connecting element (1), having an internal thread for screwing and fastening the plug connector insert in the plug connector housing (5);
a contact carrier having an insulating body (3) with a plugging side and a cable connection side situated opposite the plugging side, and a retaining plate (4) which can be latched to the insulating body (3) at the cable connection side,
wherein the cable connection side and the plugging side are connected to each other via four outer faces (31, 34), arranged at right angles to one another, of the insulating body (3), wherein one of these outer faces is a PE outer face (31),
wherein the insulating body (3) has a plurality of contact chambers (32, 321), configured as through openings, for receiving in each case one of the plug contacts (2),
wherein the contact chambers (32, 321) are oriented in a plugging direction running parallel to the outer faces (31, 34) and thus connect the cable connection side and the plugging side of the insulating body (3) to each other,
wherein one of the contact chambers (321) is arranged on the PE outer face (31) and serves to receive the PE contact (2) such that this contact chamber is a PE contact chamber (321),
wherein the PE contact chamber (321) is open in the direction of the PE outer face (31) such that a PE opening (310) is formed in the PE outer face (31) in order to enable the electrical and mechanical contacting of the PE connecting element (1) to the plug connector housing (5),
wherein the retaining plate (4)
has latching means (44,440) for latching to the insulating body (3), and furthermore
has for each contact chamber (32, 321), an insertion opening (40, 410) for insertion of the plug contact (2) into the respective contact chamber (32, 321),
wherein the insulating body (3) and the retaining plate (4) are configured to retain the plug contacts (2) to be inserted and/or which have already been inserted in the contact carrier in a latched-together state,
wherein, when the plug connector insert is assembled, the PE connecting element (1) can initially be pushed into the PE contact chamber (321) of the insulating body (3) at the cable connection side, can be retained in form-fitting fashion therein and initially movably in the plugging direction, and can be definitively fixed in the contact carrier by subsequent latching of the retaining plate (4) to the insulating body (3).

18. The plug connector insert as claimed in claim 17,
wherein the retaining plate (4) has, in order to latch each plug contact (2) inserted into the contact carrier, a latching tab (44) which projects into the respective contact chamber (32, 321) and onto which the plug contact (2) is latched with its retaining collar (23) when inserted, and
wherein the retaining plate (4) furthermore has at least one retaining rib (42) which, in the latched-together state of the retaining plate (4), abuts at the cable connection side the PE connecting element (1) inserted into the PE contact chamber (321) in order to definitively fix the PE connecting element (1) in the contact carrier.

19. The plug connector insert as claimed in claim 17,
wherein the PE connecting element (1) has at least one plugging-side fixing lug (126) for stabilizing engagement in a retaining pocket (3260), arranged at a plugging-side end of the PE contact chamber (321), of the insulating body (3).

20. The plug connector insert as claimed in claim 17,
wherein, in an unlatched state of the retaining plate (4), the PE connecting element (1) is retained movably in the plugging direction in the PE contact chamber (321) of the insulating body (3).

21. The plug connector insert as claimed in claim 17,
wherein the PE connecting element (1) is formed as a stamped and bent part from a resilient sheet-metal part.

22. The plug connector insert as claimed in claim 17,
wherein the PE connecting element (1) contacts the PE contact (2) mechanically and electrically on both sides.

23. The plug connector insert as claimed in claim 22,
wherein the PE connecting element (1) has two contact tabs (122), facing in the plugging direction and which are free-standing at their ends, for electrically and mechanically contacting the PE contact (2) of the PE contact (2) on both sides.

24. The plug connector insert as claimed in claim 23,
wherein the PE connecting element (1) has two side walls (12) and one base (11) as a contact surface,
wherein the said screw opening (10) is arranged in the base (11), and
wherein the two side walls (12) are bent at right angles to the base (11) such that the PE connecting element (1) has a substantially U-shaped cross section,
wherein each of the two contact tabs (122) is stamped from in each case one of these side walls (12) and bent slightly inward in order to contact the PE contact (2), inserted along these contact tabs (122) at the cable connection side and latched in the PE contact chamber (321), mechanically and electrically conductively on both sides.

25. The plug connector insert as claimed in claim 24,
wherein the PE connecting element (1) has at each of its two side walls (12) in each case at least one outwardly directed skid (124) for engaging behind in each case one sliding edge (314) of the insulating body (3) in order to facilitate the insertion of the PE connecting element (1) into the insulating body (3) and to retain the PE connecting element (1) in the insulating body (3).

26. The plug connector insert as claimed in claim 25,
wherein each of the said skids (314) is a constituent part of one of two guide slots (3140) oriented parallel to the PE outer face (31), arranged at the insulating body on two opposing sides of the PE contact chamber (321) beginning at the cable connection side, and running from there in the plugging direction,
wherein each of the skids (124) of the PE connecting element (1) inserted into the insulating body (3) engages in in each case one of the guide slots (3140).

27. The plug connector insert as claimed in claim 24,
wherein the retaining plate (4) has two retaining ribs (42), in each case one of which abuts in each case one of the two side walls (12) of the PE connecting element (1) in the latched-together state of the retaining plate (4).

28. An electrical plug connector, comprising:
a metal plug connector housing (5);
the plug connector insert as in claim 17 inserted therein; and
a screw (6),
wherein the plug connector insert is screwed with its PE connecting element (1) to the plug connector housing (5) by the screw (6), as a result of which its base (11) is drawn against the plug connector housing (5) from inside.

29. The electrical plug connector as claimed in claim 28,
wherein the metal plug connector housing (5) has a contact rib on an inside,
wherein, in the contact rib, the plug connector housing (5) has a cylindrical through opening for passage of the screw (6) to be screwed into the screw opening (10) of the PE connecting element (1),
wherein the contact rib on the inside of the plug connector housing (5) partially engages in the PE opening (310) of the insulating body (3) in order to be pressed against the base (11) of the PE connecting element (1) by the said screwing and thus to connect the plug connector housing (5) mechanically and electrically conductively to the PE connecting element (1).

30. A method for assembling a plug connector insert, comprising:
providing the plug connector insert as claimed in claim 17;
A. inserting the PE connecting element (1) into the PE contact chamber (321) at the cable connection side;
B. fixing the PE connecting element (1) in the PE contact chamber (321) by latching the retaining plate (4) to the insulating body (3) at the cable connection side;
C. inserting the plug contacts (2), including the PE contact (2), through in each case one of the insertion openings (40, 410) of the retaining plate (4), into the respective contact chambers (32, 321), wherein the PE contact (2) is inserted into the PE contact chamber (321); and
D. latching the plug contacts (2) in their respective contact chambers (32, 321), wherein the PE contact (2) is latched in the PE contact chamber (321) and additionally contacts the PE connecting element (1) electrically and mechanically.

31. A method for assembling an electrical plug connector, comprising:
providing the electrical plug connector as claimed in claim 28;
A. inserting the PE connecting element (1) into the PE contact chamber (321) at the cable connection side;
B. fixing the PE connecting element (1) in the PE contact chamber (321) by latching the retaining plate (4) to the insulating body (3) at the cable connection side;
C. inserting the plug contacts (2), including the PE contact (2), through in each case one of the insertion openings (40, 410) of the retaining plate (4), into the respective contact chambers (32, 321), wherein the PE contact (2) is inserted into the PE contact chamber (321);
D. latching the plug contacts (2) in their respective contact chambers (32, 321), wherein the PE contact (2) is latched in the PE contact chamber (321) and additionally contacts the PE connecting element (1) electrically and mechanically;
E. inserting the plug insert into the plug connector housing (5); and
F. fixedly screwing the plug connector insert by means of its cylindrical screw opening (10) and the screw (6) onto the plug connector housing (5) and consequently electrically conductively connecting the PE connecting element (1) to the plug connector housing (5).

32. The method as claimed in claim 31,
wherein the electrically conductive connecting of the PE connecting element (1) to the plug connector housing (5) takes place in method step F by the base (11) of the PE connecting element (1) being drawn from inside against the plug connector housing (5) by, as mentioned above, being screwed on so as to fix it, whilst the PE connecting element (1) electrically contacts the PE contact (2) on both sides simultaneously with its contact tabs (122).
